(19) United States
(12) Patent Application Publication
(10) Pub. No.: US 2007/0102064 A1
(43) Pub. Date: May 10, 2007

(54) Cross-cut log tile

(76) Inventors: Momcilo M. Filipovich, Westmont, IL (US); Milan Filipovich, Oak Brook, IL (US)

Correspondence Address: Momcilo M. Filipovich, 211 E. Naperville Road, Westmont, IL, 60559, US

(21) Appl. No.: 11/646,928

(22) Filed: Dec. 28, 2006

Related U.S. Application Data
(63) Continuation-in-part of application No. 10/944,655, filed on Sep. 20, 2004.

(51) Int. Cl. B27H 1/00; B27M 1/00

(52) U.S. Cl. 144/360

(57) ABSTRACT

The “Cross-Cut Log Tile” is a product whose primary design is to add style and luxury to homes, offices, hotels, resorts, and where ever it may be applicable. Previous to the invention of the “Cross-Cut Log Tile,” no other product on the market contained the design stated here. Traditionally, homeowners could only choose wood products that are different in color to diversify their homes and offices. The invention provides a highly decorative and flexible tile and decorating system of cross-cut timber panels selected to display the timber wood grain and growth ring patterns. The panels may be selected from a variety of timber sizes and shapes to provide unique patterns and when used in a tile system the tile size and dimensions also may be selected to provide unique patterns. As a result, the product contains a dazzling display of wood circles, with the natural beauty of wood exposed like never before.

### CROSS-REFERENCE To RELATED APPLICATION

This application is a continuation-in-part of prior application Ser. No. 10/944,655, filed Sep. 20, 2004, which is hereby incorporated herein by reference in its entirety.

### BACKGROUND OF THE INVENTION

Conventional flooring and tile products may be made of a variety of materials including wood products. Traditionally the wood flooring materials have been made of long strips or boards of wood cut in a direction parallel to the longitudinal axis of the tree from which they were taken, or panels or tiles or simulating wood panels cut in such a manner.

The “Cross-Cut Log Tile” is a new invention in the field of Home Improvement and in the field of wood products. It is designed to improve the looks and quality of homes, offices, hotels and wherever it may be applicable. It is designed to add luxury anywhere it is installed by adding genuine wood and the beauty of nature. The “Cross-Cut Log Tile” is meant to be sold side by side with other wood products such as wood flooring.

### SUMMARY OF THE INVENTION

In one aspect, the “Cross-Cut Log Tile” is a unique product that is produced by cutting logs, timber members or similar members with a wood grain and growth ring pattern into thin circular sheets or panels, then laying them flat onto a wood board or tile substrate, and joining the panels to the substrate. The tile may then be cut into predetermined sizes, including squares. Once the wood is cut into squares, it is then treated with various types of wood stain, thus giving it its rich and durable finish.

This product is intended to be used on walls and floors. It is ideal for basements, fireplaces, cabin rooms, and anywhere wood may be used. It is the world's first use of the natural beauty of wood being cut horizontally. Accordingly, the invention provides an adaptable, high decorative wood tile construction formed from cross-cut sections of timber members or comparable materials.

In another aspect, the cross-cut sections are selected to show a cross-cut view of the wood grain and growth rings of the timber member to provide a decorative surface design. The cross-cut sections may be taken in a variety of cross-cut directions, and are of sufficient thickness to provide a decorative panel that is applied to the substrate base. In another aspect, the panels are affixed to the substrate base by adhesives, screws, nails, or other forms of attachment. Additional cross-cut section panels are applied to the substrate to provide a decorative surface formed by the arrangement of individual cross-cut panels. The decorative pattern may be varied by using timber or log members of a variety of sizes and diameters.

In another aspect, a variety of different diameter or dimensioned cross-cut panels are applied to the substrate tile and a filler is applied between panels to fill in any gaps between the panels and to provide a level surface between the panels. In another aspect, the angles of the cross-cuts relative to the longitudinal axis of the timber member are varied to provide different growth ring and/or wood grain patterns. In such aspects, the cross-cut angle may be varied for about 10° to about 170° relative to the longitudinal axis of the timber member, and in other aspects the angles may be from about 45° to about 135° relative to the longitudinal angle. A selection of such varying cross-cut panels is applied to the substrate to provide additional decorative patterns. In still another aspect, further derivative designs and options are provided where the panels are cut into different shapes. The tiles also may be cut or provided in different shapes or dimensions, and the timber members further may be of different shapes and dimensions.

In yet other aspects, the individual cross-cut panels or the tiles may be stained or otherwise surface treated. A coating may be applied to the surface of the individual panels, or to the tile as a whole, to provide a coated tile surface to preserve the wood grain and ring patterns displayed on the cross-cut panels. In one aspect where such tiles are used as a flooring surface, the tile may be coated with a durable transparent or semi-transparent coating to provide a durable wear surface and to preserve the decorative appearance, grain and ring patterns displayed by the cross-cut panels.

In another aspect, the tiles are assembled on a floor or wall surface to provide an overall decorative panel. In another aspect, the spaces between the cross-cut panels may be filled with decorative devices such as stones, emblems, wood, blocks or the like to further enhance the decorative appearance of the tile.

### BRIEF DESCRIPTION OF THE DRAWINGS

FIG. 1 is a prospective view of one aspect of a tile of the invention.

FIG. 2 is a prospective view of a timber member, such as a log, and the cross-cut sections taken from the log forming the cross-cut panels for the tile of FIG. 1.

FIG. 3 provides prospective view of alternative tile shapes having decorative patterns formed thereon formed by cross-cut panels of the invention.

FIG. 4 is a prospective view of an alternative timber member providing an alternative panel configuration and the cross-cuts taken from said alternative member.

FIG. 5 is a plan view of a tile illustrating a pattern that may be formed utilizing the cross-cut panels of FIG. 4.

FIG. 6 provides examples of additional tile patterns and shapes that may be developed using the cross-cut panels of FIG. 4.

### DETAILED DESCRIPTION OF THE PREFERRED EMBODIMENT

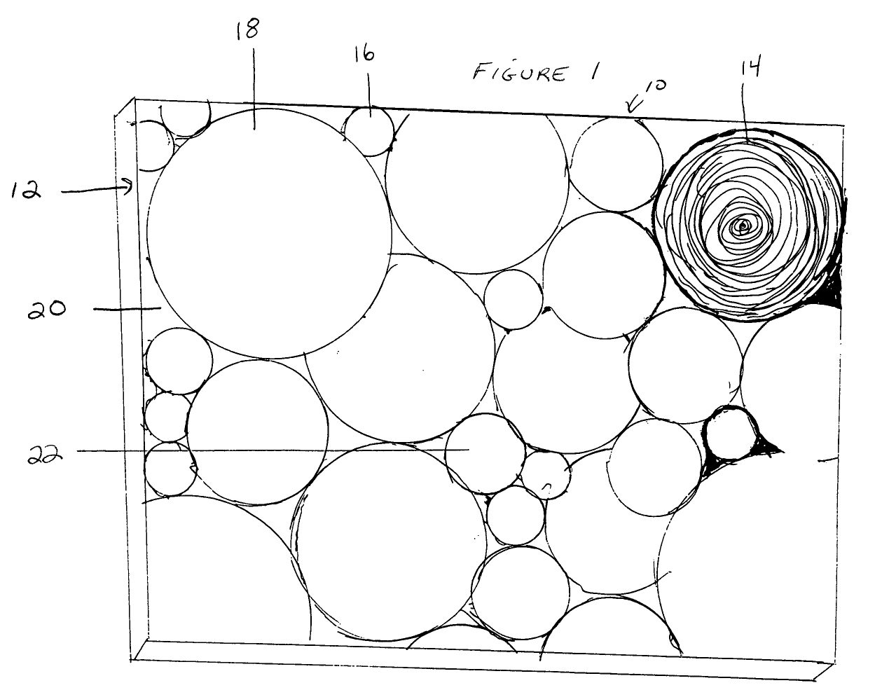

In one aspect, the “Cross-Cut Log Tile” represents the first ever use of the beauty of horizontally cut wood. In such an aspect, the product comprises thin cut sheets of wood logs, which are then positioned flat onto a wooden tile and secured using glue. As shown in FIGS. 1-5, in other aspects, the invention provides a flexible, decorative tile system utilizing cross-cut sections of timbers or similar members, displaying wood grain and wood growth ring patterns from such timber or similar members.

As shown in FIG. 1, a tile comprises a substrate 12 which may be of particle board, plywood, engineered wood or other suitable materials for receiving and securing cross-cut panels. The cross-cut panels 14, 16, 18 and 22 are mounted to the substrate 12 to provide a decorative appearance. Each of the cross-cut panels 14, 16,18 and 22 are of different diameters (although they need not be so) and are mounted in position relative to other cross-cut panels, which also may be of different shapes and diameters, to provide an overall decorative pattern.

As shown in the panel 14 each of the cross-cut panels display a growth ring and/or grain pattern obtained the cross-cuts of a wood timber member or equivalent member. The growth ring and/or wood grain pattern augments the design characteristics of cross-cut panels. In this aspect, the cross-cut panels are round or portions of round cross-cut sections taken from a log shaped timber 24. Between the cross-cut panels are spaces or interstices 20 that may be filled with a wood or sawdust fill, or transparent or colored filler material such as an epoxy, lacquer, polyurethane, polymeric or other suitable filler material. In other aspects, the interstices 20 between the panels may be left open and unfilled to provide another decorative aspect of the tile. In those applications where filler materials are applied in such interstices 20, the filler may be a variety of colors and patterns and also may have decorative inserts embedded or impressed or included within the interstices 20 to form additional decorative patterns. Such decorative inserts may comprise stones, ornaments, shells, wooden design elements or other decorative items to enhance the aesthetic appeal of the tiles.

The cross-cut panels 14, 16, 18, 22 may be attached to the substrate 12 using adhesives of various types, including acrylic, contact, epoxy or other such adhesives. They also may be attached with attachment elements such as nails, screws, staples, brads, etc.

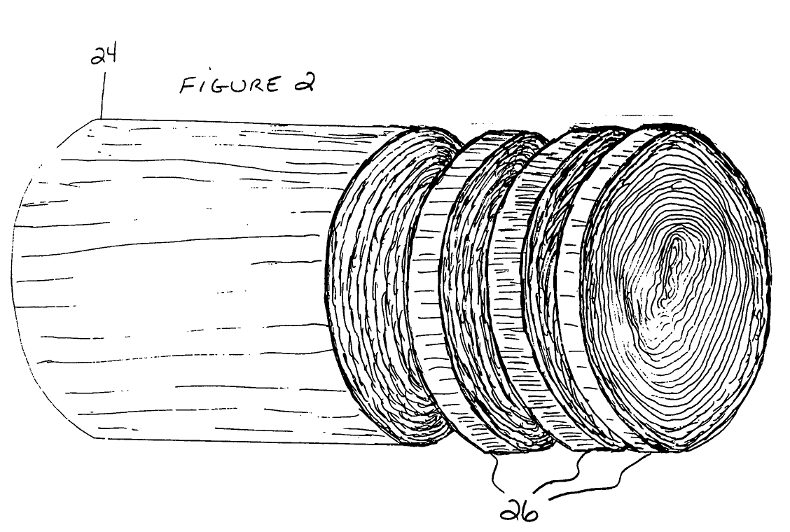

As shown in FIG. 2, the cross-cut panels 14, 16, 18, 22 may be selected from a timber member such as a log 24 (with or without back). Each cross-cut panel 26 cut from the log is selected by making a cross-cut at an angle to the longitudinal axis of the timber members. In FIG. 2, this cross-cut is shown as perpendicular to the longitudinal axis of the timber member 24, or substantially perpendicular to that longitudinal axis. In other aspects, the cross-cut panels may be taken at other angles to the longitudinal axis of the timber member, including angles such as from about 10° to about 170°, or from about 45° to about 135°, each angle providing a different wood grain and/or growth ring pattern on the surface of the panels and also potentially different panel shapes. Each of the panels 26 is of sufficient thickness to preserve its structural integrity and to permit its attachment to the substrate 12. The specific dimensions of the panels will depend on the wood grain/growth ring pattern desired and the expected use of the tile, as well as the method for cutting such panels from the timber member.

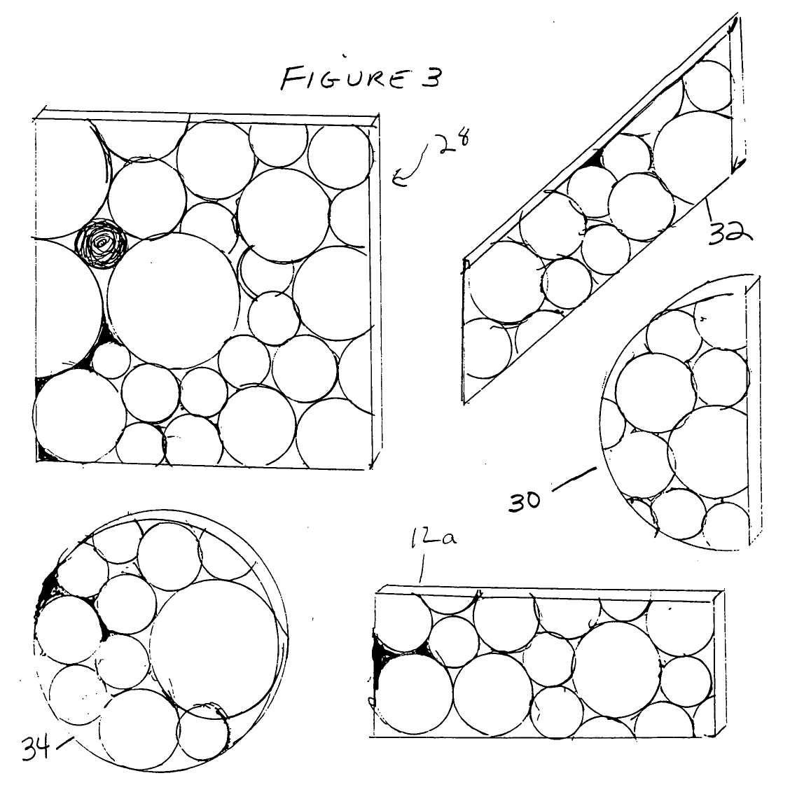

FIG. 3 shows alternative configurations for the tile utilizing cross-cut sections for various diameters. In such applications, the substrate 12 may be cut to the desired shape or the cross-cut panels may be applied to the substrates 12 and then the tile is cut to the desired size. For example, tile 12a provides another variation on a rectangular tile, and tile 28 provides an approximately square tile configuration, such as may be used on a wall application. Tile 30 provides a semi-circular tile to be used in conjunction with other tile shapes. Tile 32 provides an alternative design for the overall tile configuration where a tetragonal or trapezoidal shape is desired. The tile configuration may also be circular as shown in tile 34 where used on an individual basis and/or as a series of circular tile shapes for a surface or a wall design. Each of the panels in these embodiments is shown in outline, and each will have a cross-cut wood grain/growth ring pattern, which is not shown in FIG. 3.

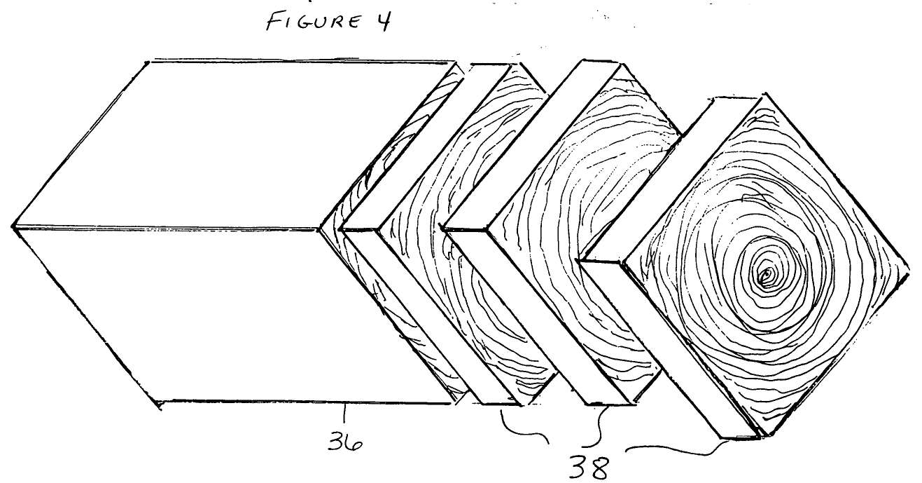

FIG. 4 shows an alternative aspect of the invention using a square or rectangular timber member 36 and alternative timber member shapes that also may be used, i.e., triangular, tetragonal, etc. The panels 38 are cross-cut from the alternative timber member 36 as discussed above. The use of the such timber members provides further options for the overall design for floor tile or floor tile system, while preserving the cross-cut growth tree ring and/or wood grain appearance provided by the invention.

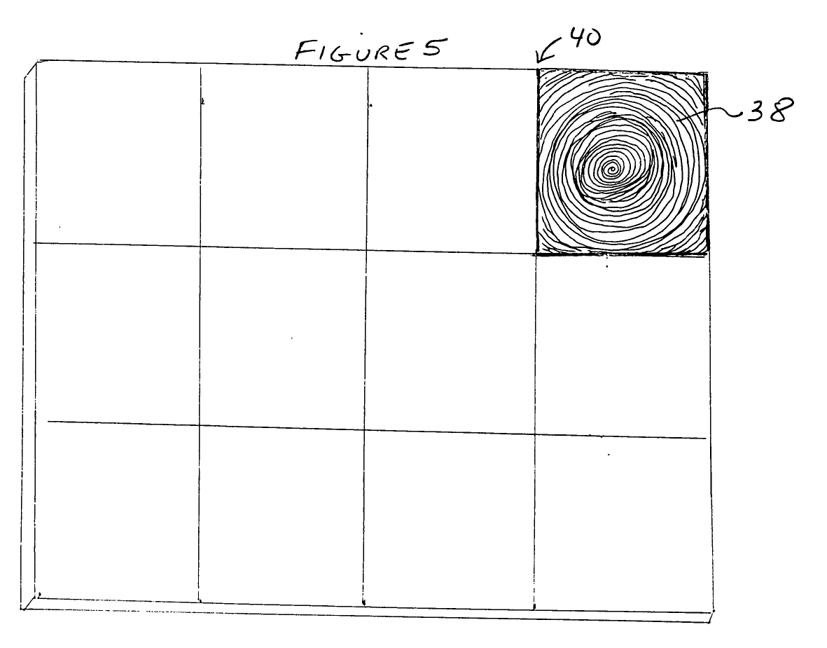

In the aspect as shown in FIG. 5, the individual cross-cut panels 38 may be laid out as an adjacent panel pattern 40 to create a floor surface (or wall surface), without the use of a substrate. In such applications, the final surface may be coated with protective layers of materials such as polyurethanes similar coatings to preserve the surface of the panels 38 and add additional decorative elements. While not shown in FIG. 5, each of the panels 38 has a cross-cut wood grain/growth ring pattern.

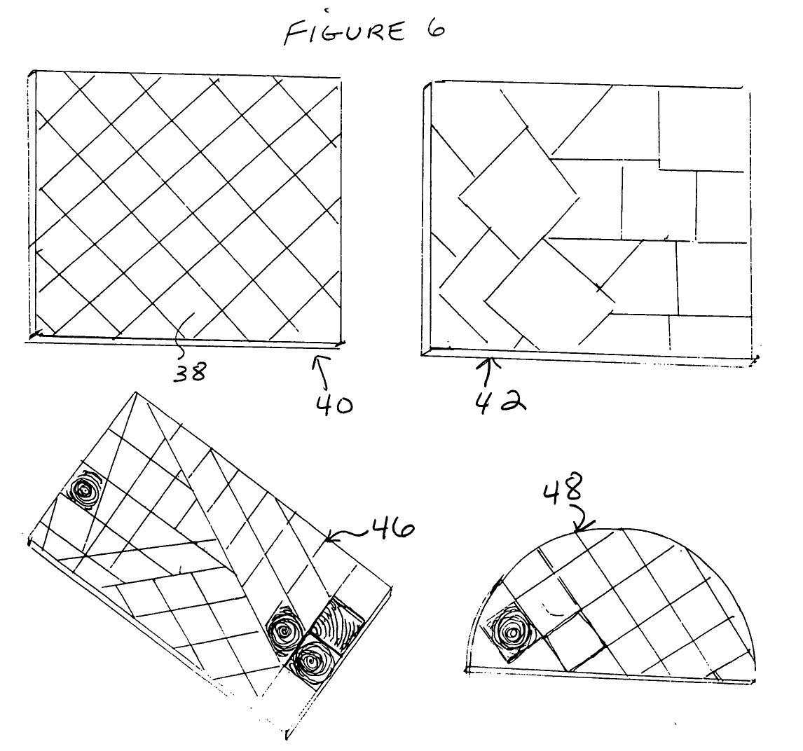

FIGS. 6 illustrates other alternative configurations 40, 42, 46 and 48 using alternative timber shapes to create additional decorative designs on individual tiles or as a floor surface attached or affixed directly to the subflooring. The tile 38 shows an example and alternative placement of the panels cut from the timber 36. The design shown in the tile 42 shows a variety of different panels cut from different shape timbers, or cut from timbers such as 36 and each panel being sectioned in different forms or directions to provide additional top surface patterns, each panel displaying the growth ring or patterns such as shown in FIG. 5.

The file patterns shown in FIGS. 46 and 48 show additional variations that may be obtained by use of the invention to provide additional ornamental designs for files or may constitute patterns applied to an existing surface in a variety of different geometrical shapes. The ability to cut the cross-cut panels from different tree timbers and further cut the individual panels to different variations provides significant flexibility and use of the invention. As with the other Figures, the cross-cut panels in the embodiments shown in FIG. 6 all have a cross-cut wood grain/growth ring pattern.

The cross-cut panels may be cut from the timbers using conventional saws, cutters and other suitable cutting apparatus. The individual panels also may be sanded or otherwise surface treated to provide a suitable decorative surface texture for the tiles or for panels applied directly to a floor or wall surface.

As discussed above, the cross-cut log file is a new product produced by cutting the logs or other timber members into panels or sheets, then displaying them flat on a substrate, such as a wooden board, joined by glue or other adhesives or fastening provisions. The files then may be cut into predetermined shapes forming squares. Once the substrate or wood is cut into files, then it may be treated with various types of wood stain, thus giving it a rich and durable finish.

This product is intended to be used on walls and floors in one aspect, but is not limited to such uses. It is suitable for basements, fireplaces, cabin rooms, and anywhere wood product may be used. It provides a unique, novel use of the natural beauty of wood by cutting the wood horizontally onto cross-cut sections.

In one aspect, the cross-cut log file begins its life as timber, cut horizontally into foot long pieces. These pieces are then carefully cut into quarter inch sheets further making them flatter and easier to work with. A large piece of flat wood board of plywood or another substrate is covered with wood glue or a similar adhesive and these thin sheets of log are placed flat on top of the wood. Separately, the byproduct is that sawdust may be mixed with glue into a paste that is then used to fill the gaps between the log sheets.

Once the glue is cured, and the logs are in place, the product may be cut into various tile sizes. Depending on their intended use, they may be anywhere from a foot by foot (12 inches by 12 inches) or larger. The tiles may then be sanded on every surface making them smooth to the touch. The sandy and surface treatments improve and/or polish the wood and show the natural beauty of the wood growth ring and grain patterns, with circle logs, creating a maze of circles within a tile.

In this aspect, in the final step, the tiles are dipped into wood finish to create natural beauty and providing product durability and protection of the elements.

What makes the “Cross-Cut Log Tile” such a breakthrough product is that is has the potential to change the entire market. Never before has wood been used in a fashion such as this. For a long time, wood products were always made in the same fashion. They were cut vertically, into a long and very narrow boards. The perfect example would be conventional wood flooring. Though beautiful, the wood floors always looked the same, as there was never any real variation. They were always cut in the same fashion, and made the same way.

Unlike regular wood flooring products, the product of the invention also may be used on walls due to its unique design and flexibility. When taking into consideration that there are many species of wood, many different wood stains and finishes, the combination of art and size of the aesthetic design provided by the invention provides greater flexibility and variety than available through other products.

The “Cross-Cut Log Tile” is very easy to make, and the cost is minimal. The average adult can make this product in their garage being that the supplies and the machines needed can be found in any hardware store. Thus, due to its relatively low cost and ease of instruction, this invention is suited for use in “do it yourself” applications by consumers, or may be utilized by professionals in the home decorating floor and home construction business.

What is claimed is:

1. A decorative tile system comprising:
one or more tile substrate bases each having a predetermined shape and dimensions;
a plurality of cross-cut panels selected from sections of a timber member having a longitudinal axis; the sections cut in an angular direction relative to the timber longitudinal axis, the cross-cut angle selected to display a pattern of wood grain comprising growth rings of the timber; and
the cross-cut panels affixed to each substrate base in a decorative pattern.

2. The system of claim 1, wherein the cross-cut angle is from about 10° to about 170° relative to the timber longitudinal axis.

3. The system of claim 2 wherein the cross-cut angle is about 45° to 135° relative to the timber longitudinal axis.

4. The system of claim 3 wherein the cross-cut angle is approximately 90° relative to the timber longitudinal axis.

5. The system of claim 1 wherein the cross-cut sections are taken from timber members of different external dimensions and are arranged on each substrate base in a decorative pattern.

6. The system of claim 1 wherein the panels are affixed to each substrate bases to provide interstices between the panels, and the interstices are filled with a filler material.

7. The tile system of claim 6 wherein ornamental decorations are supplied in the panel interstices and are embedded in the filler material.

8. The tile system of claim 1 wherein the substrate bases are cut into geometric shapes.

9. The system of claim 1 wherein the file system is provided with a durable coating sufficiently to cover and protect the surfaces of the cross-cut panels.

10. The tile system of claim 1 wherein the cross-cut sections are cut into smaller sections of predetermined shape and to provide a decorative pattern on the files.

11. The system of claim 1 wherein the timber member is a polygon.

12. A decorative panel system comprising:
panels selected from cross-cut sections taken from a timber member having a central longitudinal axis, the sections cut at an angle from about 10° to about 170° from the longitudinal angle;
the panels having a different dimensions and arranged on a receiving surface;
the panels arranged to provide a decorative pattern; and a sealer is applied to the panel surface to protect and preserve the panel surfaces.

13. The system of claim 12 wherein the panels are positioned such that there are interstices between the panels; and a filler material fills the interstices.

14. The system of claim 12 wherein the panels form a floor surface.

15. A method for making a decorative tile system comprising:
providing a timber member with a longitudinal axis;
cutting sections for the timber on an angle from about 10° to about 170° relative to the longitudinal axis, to display a wood grain pattern comprising growth rings of the timber, and a selecting cross-cut panels from the segments;
affixing the panels to a substrate base having a predetermined shape and dimension in a decorative pattern; and
applying a preservative coating to the panels.

16. The method of claim 15 wherein timbers with more than one diameter are provided and the panels cut from such timbers are arranged on the tile substrate in decorative patterns.

17. The method of claim 16 wherein a filler material is applied in the interstices between the panels mounted on the tile substrate.
